(19) United States
(12) Patent Application Publication
(10) Pub. No.: US 2003/0167197 A1
(43) Pub. Date: Sep. 4, 2003

(54) Customer relationship measurement and management system and method

(75) Inventors: Randall D. Shoemaker, Indianapolis, IN (US); G. Michael Grindstaff, Carmel, IN (US); Brian A. Kovacs, Greenwood, IN (US); Mark L. Weimer, Noblesville, IN (US); Bill Easton, Indianapolis, IN (US); Mark R. Glodowski, Indianapolis, IN (US); William Doyle, Indianapolis, IN (US)

Correspondence Address: Russell E. Fowler, II, ICE MILLER, One American Square, Box 82001, Indianapolis, IN, 46282-0002, US

(73) Assignee: Walker Information

(21) Appl. No.: 09/896,960

(22) Filed: Jun. 29, 2001

Related U.S. Application Data
(60) Provisional application No. 60/215,309, filed on Jun. 30, 2000.

(51) Int. Cl. G06F 17/60

(52) U.S. Cl. 705/10

(57) ABSTRACT

The present invention is a customer relationship measurement and management system and method using the Internet. The system includes a central computer linking various remote computers via the Internet. The central computer hosts an Internet website which provides a company with an account management tool and a customer survey tool. The account management tool allows the company to input account information and company hierarchy information into a database. The customer survey tool distributes surveys to various customer respondents using an e-mail invitation with an embedded URL link. Customer respondents complete survey questions on-line, and survey responses are returned to the central computer upon completion of each survey. An algorithm is applied to each survey to score the survey and determine if the customer completing the survey should be contacted for follow-up action. Action plans are developed and entered into the database for each customer requiring follow-up action. Results obtained from implementation of each action plan are scored and recorded in the database. Account managers may search the database for successful action plans that respond to particular customer issues. The most successful action plans are distributed to other managers within the company hierarchy.

### BACKGROUND

Market research is a tool used by many businesses and other organizations to assess the audiences or stakeholders that are important to their continued success. One important goal of market research is to provide businesses with information about the non-financial aspects of doing business. In order to prosper and grow, businesses need information about their relationships with their stakeholders (i.e., those individuals or entities that have some stake in the organization, and the organization, in turn, has some stake in them). Stakeholders may include, but are not limited to, customers, employees, investors, unions, suppliers, alliance partners, industry associations, local communities, consumer/user associations, special interest groups/non-governmental organizations, media, government regulators, competitors, outside board directors, the general public (beyond local communities), financial analysts, lenders and education leaders. The term “customer” as used herein may also refer generally to any of an organization's stakeholders. Examples of stakeholder relationship information that market research may obtain includes information on customer satisfaction, customer loyalty, corporate reputation, and employee commitment. This type of market research helps companies focus on the critical aspects that drive their relationships with customers, employees shareholders and communities. Companies use this objective data in combination with traditional financial measures to better serve all their valuable stakeholders, and measure and plan for business success.

Customer relationship measurements are presently accomplished by taking surveys, compiling and collecting data from the surveys, and preparing reports about the data collected. Surveys are typically mailed to customers or taken over the telephone by a market research firm. After the market research firm collects answers from all survey respondents, the survey information must be compiled and collected into aggregate reports which disclose information about the survey population as a whole. The process of compiling survey information and preparing reports typically takes several weeks, as the market research firm must collect survey information into a central location, translate any foreign language surveys, and analyze the survey trends for inclusion in the aggregate reports.

While the aggregate reports prepared by market research firms provide valuable information to companies about their customer relationships, the reports are typically unacceptable for various reasons. First, companies often do not know how to act upon information disclosed in aggregate reports. Any action taken is generally in response to the overall survey results, and no mechanism is provided for responding to individual survey results. Second, valuable information is often lost concerning specific problems with specific customers. Thus, companies are not even given the opportunity to respond to the specific complaints of specific customers in an attempt to satisfy and retain the customers. Third, even if companies were provided with the opportunity to respond to specific customer complaints, the turn around time of a typical survey process could result in customers switching to other competitors before the companies are provided with the opportunity to address the customer complaint. Furthermore, when companies do take actions to improve relationships with specific customers, there is currently no mechanism for sharing successful practices with other employees, thereby empowering the other employees with ideas on responding to particular types of customer complaints.

For the foregoing reasons, there is a need in the customer satisfaction measurement industry for a system and method for surveying a number of customers and identifying specific issues with specific customers in addition to aggregate customer information. There is also a need in the industry for a system and method of surveying a number of customers where individualized survey results are compiled and made available almost immediately after the survey results are collected. Furthermore, there is a need for a system that can provide recommended action plans based upon research results and past customer relationships.

### SUMMARY

The present invention is a customer relationship measurement and management system and method using the Internet. The method of the present invention is summarized with reference to FIG. 9. As shown in FIG. 9, a company hierarchy is first defined in step 1. The company hierarchy includes all customer accounts and account managers responsible for such accounts. In addition, the company hierarchy defines high-level managers responsible for account managers. In steps 2 and 3, this hierarchy is then stored in a database. The database may be modified by the company using a web-enabled customer management tool. Next, in steps 4 and 5, web surveys are created and distributed to customer employees using an e-mail invitation with an embedded URL which provides each customer employee with access to a survey in the employee's language. Customer employees then log on to the web page identified by the URL, as shown in steps 6, 7 and 8, and work through the survey questions presented by simply clicking on answers in response to the various multiple choice questions, and typing in answers to written questions. Next, in steps 9 and 10, an algorithm is applied to each survey to score the survey and determine if the customer completing the survey should be contacted for follow-up action. In step 11, reports of flagged or “at risk” customers are provided to account managers based upon their responsibility for each at risk customer according to the company hierarchy stored in the database. An action plan in response to issues of each at risk customer is developed by the account manager and recorded in the system in step 12. Results obtained from implementation of the action plan are also recorded in the system as shown in step 13. In step 14, the implemented action plans are scored and archived within the system for sharing with other account managers. Finally, in step 15, the most successful action plans are distributed to other managers within the company hierarchy. These managers can then review the action plans, award account managers who developed the action plans and/or share the successful action plans with other managers within the company.

In the above manner, the present invention satisfies the need for a customer relationship measurement and management system which provides immediate access to individualized survey results and offers recommended action plans based upon the survey results. These and other features, aspects, and advantages of the present invention will become better understood with reference to the following description.

### BRIEF DESCRIPTION OF THE DRAWINGS

FIG. 1 shows an overview of the components of a customer relationship measurement and management system, including an account management tool and a customer survey tool;

FIG. 2 shows an account listing page of the account management tool of FIG. 1;

FIG. 3 shows an account information page of the account management tool of FIG. 1;

FIG. 4 shows a respondent data page of the account management tool of FIG. 1;

FIG. 5 shows a respondent survey page of the customer survey tool of FIG. 1;

FIG. 6 shows a customer follow-up page of the account management tool of FIG. 1;

FIG. 7 shows a respondent action page of the account management tool of FIG. 1;

FIG. 8 shows a results page of the account management tool of FIG. 1;

FIG. 9 shows the method used by the customer relationship measurement and management system of FIG. 1.

FIG. 10 shows a survey translation process for the customer relationship and management system of FIG. 1

### DESCRIPTION

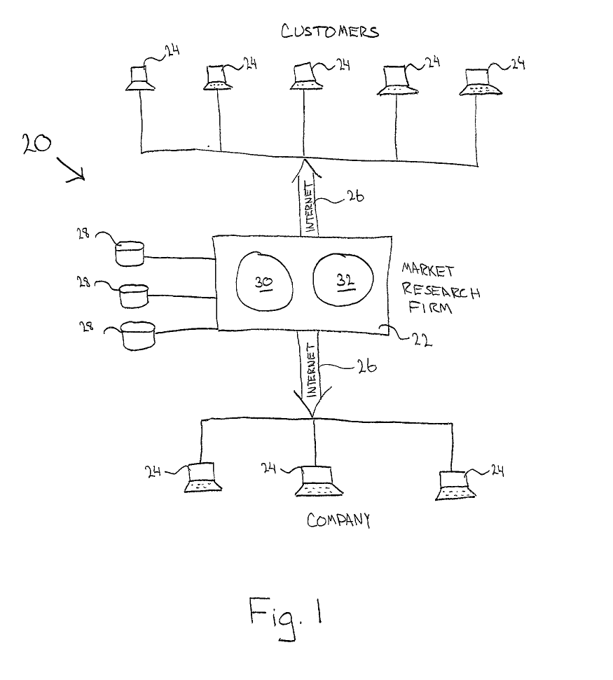

One embodiment of the present invention is now described in more detail with reference to the above figures. As shown in FIG. 1, a Customer Relationship Measurement and Management System 20 includes a central computer 22 (e.g., a server) linking various remote computers 24 via a network such as the Internet 26. The central computer is controlled by a market research firm and hosts an Internet website which provides a company with an account management software tool 30. The central computer also hosts a website which provides the company's customers with access to a customer survey tool 32. Both the account management tool 30 and the customer survey tool 32 are software tools written in hypertext markup language (html), or other language commonly found for world-wide-web applications, and both are accessible by authorized users via remote computers 24 connected to the Internet. The central computer 22 has access to a plurality of databases 28 which contain information about the company and the company's customers. For example, the databases contain information about the company hierarchy from top-level management through individual account managers responsible for particular customer accounts. The databases also contain information about the company's customer accounts and individual contacts that work for those customers. A company account manager is associated with each individual contact in the database.

Company managers are each provided with a username and a password for use when logging on to use the account management tool 30. After visiting the Internet website and entering a valid username and password, the manager is provided access to the account management tool 30. The account management tool 30 provides managers with a number of resources, including information about various accounts, survey information collected by the market research firm, and customer follow up information. Managers are provided with access to information based upon their particular clearance level. For example, a high-level manager may have access to information about various accounts handled by various account managers, while lower-level account managers may only be provided with access to information about those accounts for which they are responsible.

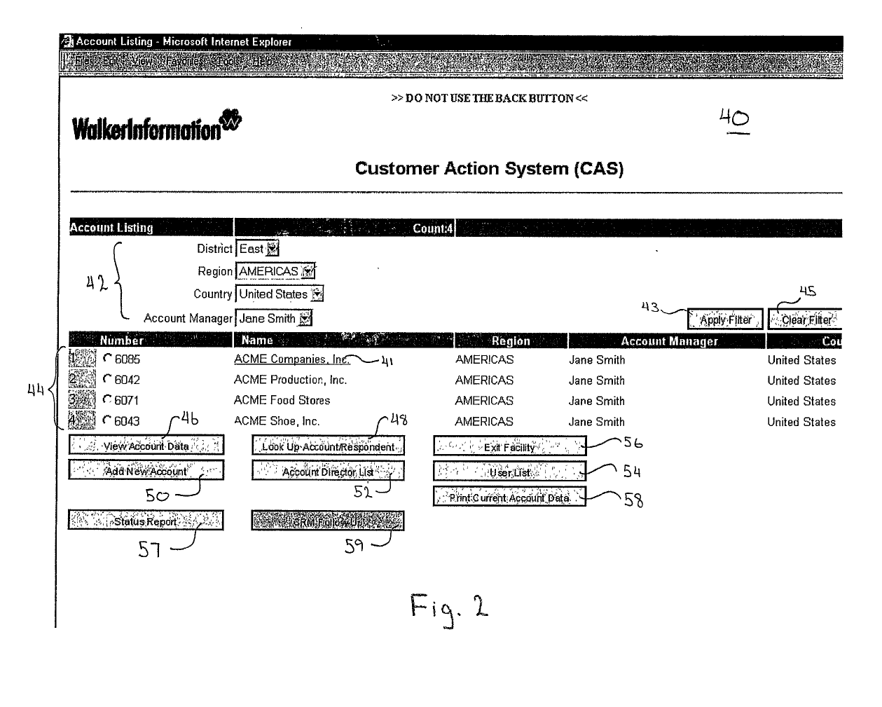

After a valid username and password is entered by an account manager, the account manager is provided an account listing page 40 on the screen of the remote computer 24, as shown in FIG. 2. The account manager may navigate the account listing page, and other pages of the account management tool 30 accessible through the account listing page, by using a mouse or other user interface device connected to the remote computer 24 to choose the appropriate options. The account listing page shows all accounts for particular account managers in a particular geographic area. A search tool 42 allows the manager to search for the accounts of a particular account manager in a particular geographic region, as defined by the company. For example, a company may split worldwide accounts into districts, regions and countries, as indicated by the search tool 42 of FIG. 2. High-level managers are allowed to view account information for all account mangers under them within the company hierarchy, while lower-level account managers are only allowed access to search for information about their own accounts. Once a search is defined, the user clicks on the apply filter button 43 to execute the search. A clear filter button 45 is also available if the user wishes to remove the present search and enter a new search.

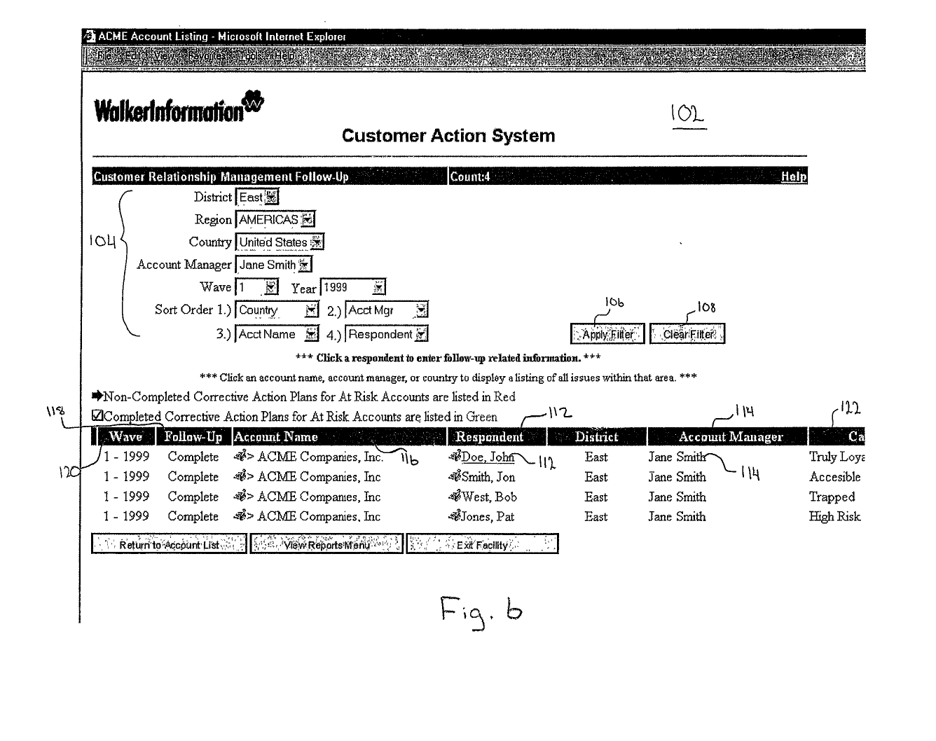

After searching the accounts of a particular account manager using the search tool 42, an account list 44 is displayed below the search tool 42. Each row of the account list 44 includes an account number, account name 41, account manager, and account location. More detailed information about a particular account may be obtained by clicking on the account name 41 or number from the account list 44 and then clicking the view account data button 46. If the user does not readily see a particular account of interest on the account list, such as when a large number of accounts exist in the account list, the look-up account button 48 may be chosen to assist the user in finding the account of interest. Another option available to the user includes the option to add a new account 50. Once information about a new account is entered, it is stored in the databases 28 and the information is included when the manager uses the account management tool. Other options available to the user include the option to view the account director list 52, view a list of all users 54, print current account data 58, or exit the account management tool 56. Additionally, the user may view a status report which indicates customers recently added or deleted by the account manager by choosing the status report option 57. The CRM (Customer Relationship Measurement) follow-up option 59 links the user to a customer follow-up page 102, which is described in more detail below with reference to FIG. 6.

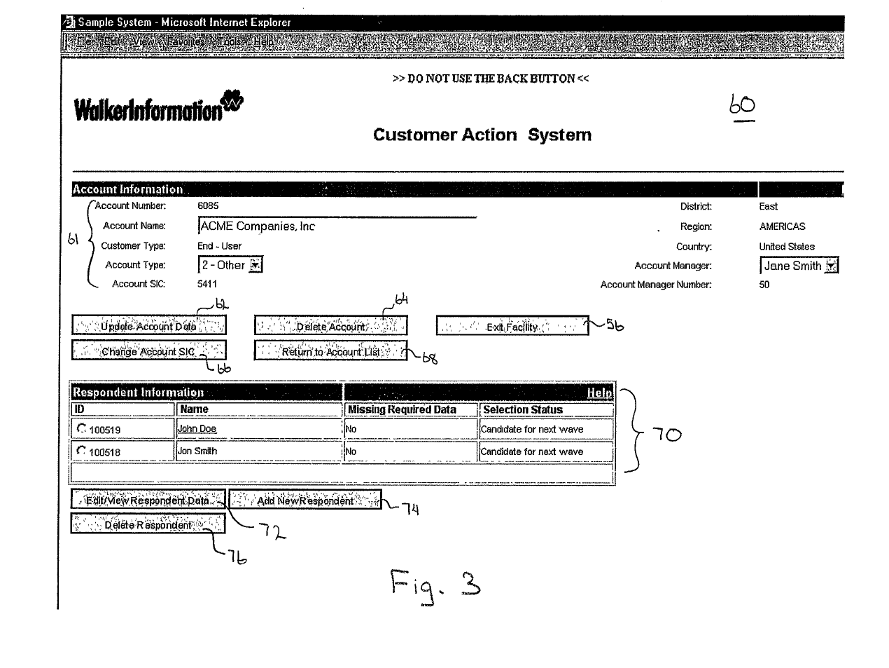

When the view account data button 46 is chosen by the user, an account information page 60 is shown on the screen of the remote computer. An exemplary account info page 60 is shown in FIG. 3. Detailed account information 61 is displayed along the top of the screen, including information about the geographic location of the account and the account manager. The user may choose to update the account information 62, delete the account 64, change the account standard industry code (SIC) 66, return to the account list 68 or exit the account management tool 56.

Below the detailed account information 60 is a table of respondent information 70 for the account. Respondents are individual contacts that are surveyed for the purposes of market research. The respondents are typically employees of the customers having business relationships with the account managers. The user may choose to view/edit respondent data 72, add a new respondent 74, or delete a particular respondent 76.

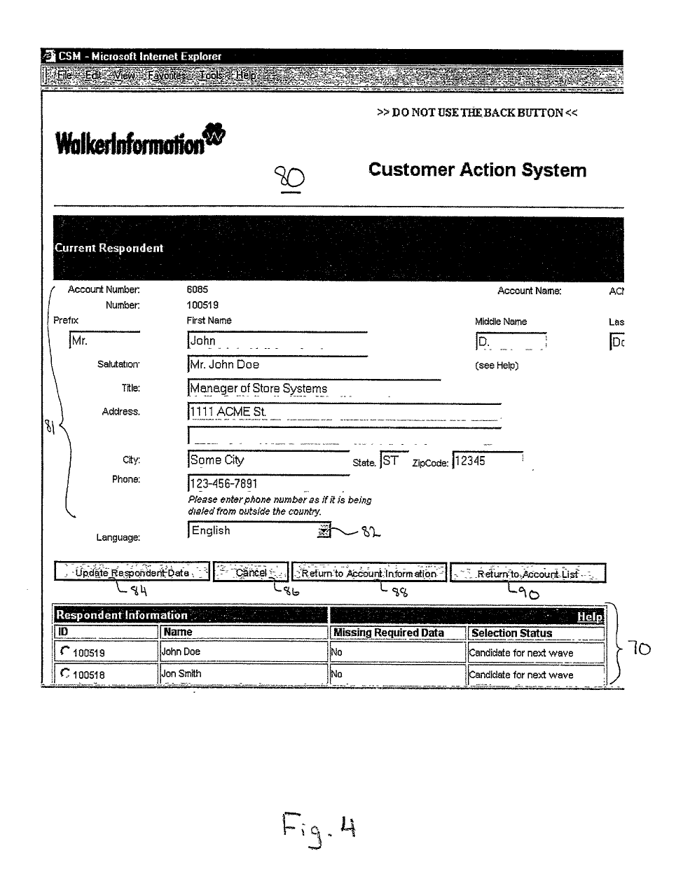

By clicking on the respondent name and choosing the view/edit respondent data option 72, a respondent data page 80 is displayed. An exemplary respondent data page 80 is shown in FIG. 4. The respondent data page includes contact information 81 for the respondent including name, address, phone number, and e-mail. In addition, the respondent data page allows the user to define the language the respondent speaks under language option 82. This language will be used when the respondent is contacted by the system 20 and requested to participate in a market research survey. If the respondent agrees to participate, the survey is also provided to the respondent in this language. Below the respondent contact information 81, the user is provided with the option to update the respondent data 84, cancel any new data entered 86, return to the account information page 88, or return to the account listing page 90. The respondent information table 70 is also shown on the bottom of the respondent data page 80.

With respondent information entered into the databases, the system 20 is in position to contact some or all of the respondents and survey the respondents about company performance and other market conditions. The market research firm creates a customer survey unique to the company for distribution to respondents. The customer survey asks a number of customer satisfaction questions designed to pull relevant information from respondents about their relationship with and impression of the company and its products or services. The term “customer satisfaction” is also used herein to refer to stakeholder loyalty.

Customer surveys are translated into the language of the respondent as identified by the user inputting information about the respondent under the language option 82. The surveys are distributed to some of the respondents based on a random sampling procedure of the market research firm or, alternatively, by designation of specific respondents by the account managers of the company, such as all respondents entered into the system.

To distribute the surveys, the central computer 22 sends e-mail messages to each of the respondents in their own language. Each e-mail message includes an invitation to complete an on-line market research survey as well as a uniform resource locator (URL) link to the company's on-line survey located at the website where the customer survey tool 32 is hosted. The e-mail message to each respondent may also include a password for use by the respondent for identification and authentication purposes when actually taking the on-line survey. The e-mail message may also offer incentives to the respondent to encourage them to participate in the survey.

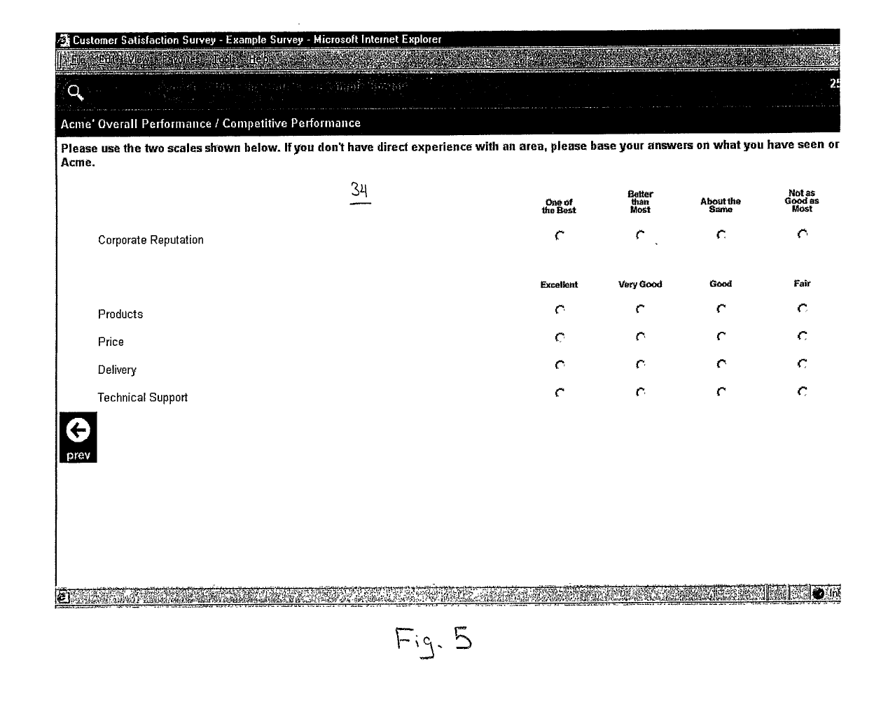

Respondents use one of the remote computers 24 to access the surveys by entering the URL address in their browser or, if a URL link is provided with an e-mail invitation, the respondent simply clicks on the URL link within the e-mail invitation. After arriving at the URL address and entering the appropriate identification and authentication information, if any, the respondent is provided access to the customer survey tool 32. Once the respondents access the customer survey tool 32, the respondents are lead through various pages of a customer satisfaction survey 34 (also referred to herein as an “on-line survey”). Each respondent's answers are stored within the databases 28 when the respondent completes the on-line survey. A page from an exemplary survey 34 is shown in FIG. 5. The survey asks questions in the area of customer loyalty and satisfaction, including questions concerning the customers perception of the company in the areas of value, quality, and price of the company products and/or services. The survey 34 accepts multiple choice answers from the respondents based upon their experience with the company. In addition, the survey may allow respondents to enter text answers and comments to certain questions.

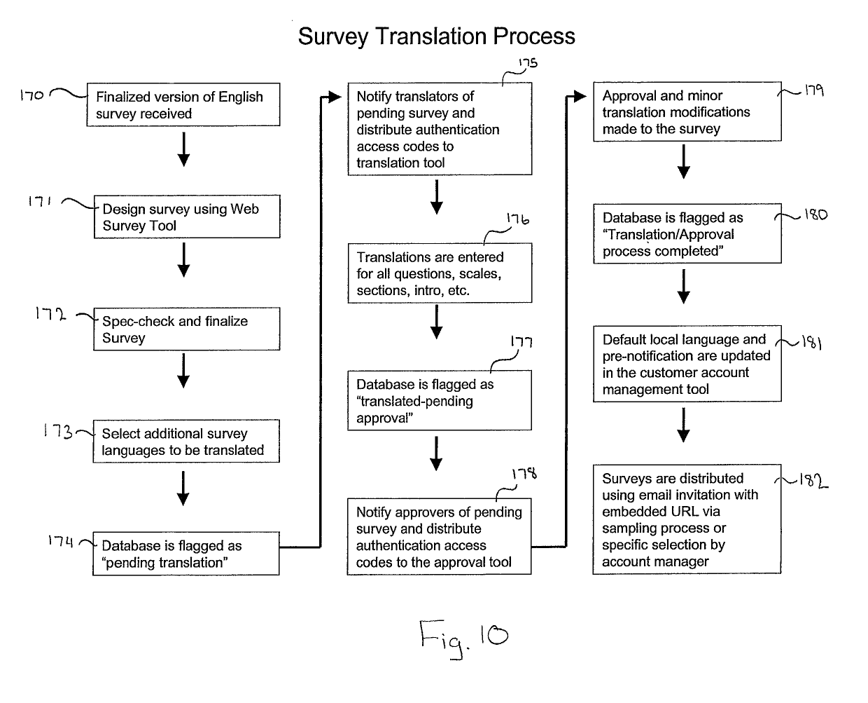

As mentioned previously, the survey may be distributed to the respondent in any of a number of different languages, based on the language associated with the respondent under the language option 82 on the respondent data page 80, shown in FIG. 4. When a respondent is associated with a language other than English, the survey for distribution to that respondent is first delivered to a translator for translation purposes. The survey translation process is disclosed in FIG. 10.

As shown in FIG. 10., the first step 170 of the survey translation process is completion of a final version of a survey in the English language. In the next step 171, the English language survey is entered into the system 20 and stored in one of the system databases 28 using a web survey tool (not shown). After the survey is checked for accuracy and completeness in step 172, various languages are associated with the survey for translation purposes in step 173. These languages correspond to languages to be associated with various respondents that will be requested to complete the survey. After desired translation languages are associated with the survey, the survey is flagged as a “pending translation” in the database 28 in step 174. Next, in step 175, translators are notified via e-mail that a survey needs to be translated. The translators are responsible for translating the entire survey including all survey questions, scales, introduction materials, and section comments from the default language (i.e., English) to the additional native language(s) associated with the survey. The e-mail messages sent to the translators include a link to a translation tool (not shown) and authentication and access codes for accessing the translation tool.

The translation tool is a web page hosted by the system that provides a mechanism for translators to easily translate the surveys from one language into multiple languages. The translation tool takes the translators through the survey one question at a time, allowing the translator to provide a translation of each question, any associated multiple choice responses, and any other survey comments. The underlying database structures for the translation tool support the UTF8 encoding scheme. The UTF8 encoding scheme is a superset of over thirty of the world's languages (encoding schemes). The database structures further support regional encoding schemes and can convert from the regional encoding to the UTF8 encoding and back, thereby providing a single database to manage all languages. For example, Japanese character set SHIFT-JIS being stored in the database will be converted to UTF8 upon database entry and converted back to SHIFT-JIS upon removal. This conversion process is necessary because not all Internet browsers have full support for UTF8. Once all the leading Internet browsers support UTF8, this conversion process can be eliminated.

Once all survey translations are entered, including translations for all survey questions, scales, introduction materials, and section comments, as noted in step 176, the survey translations are flagged in the database as “translated, but pending approval” in step 177. Next, as indicated in step 178, translation approvers are notified via e-mail that translated surveys needs to be approved. The e-mail messages sent to the translation approvers include a link to the translation tool (not shown) and authentication and access codes for accessing the translation tool. The translation approvers are responsible for reviewing and validating all survey translations from the translators. The translation tool takes a translation approver through each survey question, and each survey question is either approved or modified by the translation approver, as indicated in step 179. Once a complete survey translation is finally approved by a translation approver, it is flagged in the database as “approved.” This process continues until each survey translation is completely approved for all languages, as noted in step 180. In step 181, any survey language defaults are updated in the account management tool 30. Finally, in step 182, surveys are distributed to respondents.

Once a survey is translated, an e-mail message is sent to the respondent, inviting the respondent to access the survey in his or her own language at the provided website. Harvesting multiple choice answers is not problematic between various foreign language surveys because the survey tool provides accurate survey translations, and the highest multiple choice answer in one language is recorded by the system as the same answer as the highest multiple choice answer in another language. However, because the surveys sometimes ask respondents to provide written answers, these translations are more difficult. To this end, the system must be able to recognize various characters from around the world, such as Japanese and Chinese characters entered by survey respondents. Characters in these languages are often referred to as “double-byte” characters. The system 20 then sends the strings of text containing double-byte characters to various translators for translation back into the default language (i.e., English). The same process is used for translating comments back into English as was used for translating surveys into various languages. As the text strings are translated back into English, they are associated with the respective respondent's survey answers and saved in the databases 28.

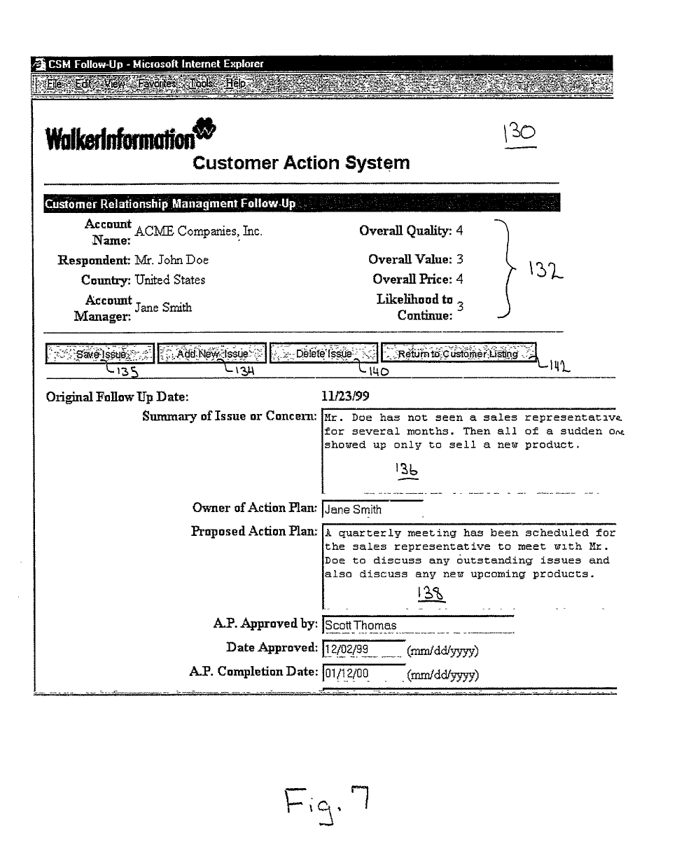

Once respondents complete their surveys, the respondents log out of the customer survey tool 32 and the survey answers are sent to the central computer 22 through the network 26. The central computer 22 receives the survey answers through the network and stores the answers in the databases 28. For each respondent, the central computer 22 automatically processes the survey answers and provides various customer satisfaction scores. The central computer uses pre-established criteria to analyze the survey answers received from a selected respondent and provide customer satisfaction scores for that respondent. For example, if a respondent answers questions six, seven and eight of the survey with a particular series of answers such as “b”, “d” and “c”, the respondent's customer satisfaction score for the overall quality of company's product may be determined to be only a “two” out of a possible score of “five”. Thus, the system is capable of identifying a customer satisfaction issue concerning the quality of the company's product because the respondent's customer satisfaction score for the quality of the company's product is low. The system then generates a customer satisfaction report for the respondent, such as that shown in FIG. 7. As shown in FIG. 7, the report for the individual respondent includes the respondent name, account name and account manager along with a survey summary 132 showing a number of customer satisfaction scores. Low customer satisfaction scores identify customer satisfaction issues in particular areas such as quality, value, and price. Of course, the system may be designed to provide customer satisfaction scores for any number of possible customer satisfaction issues which the survey is designed to analyze. Furthermore, the survey may provide the respondent with the opportunity to write-in a customer satisfaction issue that the respondent wants to stress to the company. In addition to providing customer satisfaction scores and allowing customers to provide their own customer satisfaction issues, the reports for individual respondents may include other information such as answers to all or a limited number of actual questions asked in the survey.

In addition to analyzing survey answers and providing reports on an individual respondent basis, the central computer also analyzes survey answers on an account basis and a company-wide basis. While individual reports may show how the respondent answered each question and identify customer satisfaction scores for the respondent, account reports show the average customer satisfaction scores for the aggregate of all respondents answering for the same account. Likewise, company-wide reports show average customer satisfaction scores for the aggregate of all respondents from all accounts. These various reports are automatically generated by the central computer 22, stored in the databases 28, and made available to the account managers almost immediately after respondents complete survey results. There is no need for the market research firm to spend days compiling survey results or separately entering the results into the system in order to generate reports. The market research firm may automatically e-mail or otherwise send to the company account reports and company-wide reports on a periodic basis, as additional respondent surveys are completed. In addition, certain individuals within the company with high-level access may view the report results at any time through the account management software tool.

In addition to scoring results and generating reports, the system 20 also analyzes survey results to determine if follow-up action is necessary. For example, based upon the customer satisfaction issues identified by the customer satisfaction scores, the system 20 may categorize a particular respondent or customer in one of several risk categories such as “truly loyal”, “accessible”, “trapped”, or “high risk”. “Truly loyal” customers are those customers that the company is very likely to retain. “Accessible” customers are those customers that the company has a good chance of retaining, but the company should focus on developing a deeper loyalty in accessible customers. “Trapped” customers are those customers that have no choice but to purchase from the company because of the nature of the market, e.g., company is the sole supplier of a particular good. “High risk” customers, for example, are those that the company is likely to loose to a competitor. Based upon the categorizations, the system 20 then determines which respondents require follow-up action by the company. For example, the system 20 may determine that high risk, trapped, and accessible customers are all “at risk” customers and require follow-up action by account managers. The system 20 then flags all respondents employed by these “at risk” customers to indicate that the respondents require follow-up action. Alternatively, depending upon the particular customer and the system desired by the company, the system may be set up to only flag respondents themselves as “at risk” without identifying particular customers as “at risk”. In any event, account managers viewing the account of an “at risk” customer (or a customer having “at risk” respondents) will readily see that particular respondents require follow-up action because the flagged respondents will stand out from other respondents.

FIG. 6 shows a customer follow-up page 102 of the account management tool 30 used by account managers to view survey results, including “at risk” customers, from one of the plurality of remote computers 24. The customer follow-up page 102 may be accessed by clicking the status report option 57 shown on the account listing page 40 of FIG. 2. Several search criteria 104 are shown at the top of the customer follow-up page 102. For example, customer accounts may be searched by geographic location, name of account manager, and year of customer survey. If the user makes a mistake when defining criteria, the clear filter option 108 may be chosen and new search criteria may be entered. Once the desired criteria are entered, the user selects the apply filter option 106, and the system searches for respondent information meeting the defined criteria.

Search results 110 are displayed at the bottom of the customer follow-up page 102. The search results are provided in the form of a list of respondents meeting the defined criteria. Information about each respondent is provided in rows of the list. This information includes the respondent name 112, the account manager 114, the account name 116, follow-up status 118, year of survey 120, and customer/respondent category 122 based upon survey results. Respondents requiring follow up action are flagged to highlight the respondents to account managers. For example, at risk accounts with uncompleted action plans are shown in red. At risk account with completed action plans are shown in green. Non-risk accounts are not flagged and are shown in black

By selecting one of the respondents 112 from the search results 110, the account manager is provided with access to the respondent action page 130 (which may also be referred to herein as a “customer action page”). As shown in FIG. 7, the respondent action page 130 provides a respondent survey summary 132 or similar report. The survey summary 132 lists the customer account, respondent name, and account manager. The survey summary 132 also includes a summary of the respondent's survey results, such as the average score given by the respondent for overall quality, overall value, overall price, and likelihood to continue purchasing the company's products or services.

Issues of concern (i.e., “customer satisfaction issues”) to at risk customers may be automatically identified by the system based upon a respondent's answers. For example, if a customer answers a particular group of multiple choice survey questions in a certain manner, the system is able to identify that the customer has a particular customer satisfaction issue. A written description of that issue is then automatically inserted into an issue box 136 on the respondent action page. As another example, customers may be asked to enter a written description of any customer satisfaction issues of concern in response to a survey question. These issues may then be inserted into issue box 136 for viewing by the account manager. Alternatively, customer satisfaction issues to at risk customers may be manually entered into the system by account managers. For example, an account manager may identify an issue of concern to a customer during follow-up meetings with the customer. Once such an issue is identified, the account manager chooses the add new issue option 134 on the respondent action page 130 and manually adds the issue of concern into issue box 136. Once issues of concern are entered into the system, they may be saved using the save issue option 135.

After identifying an issue of concern and entering it into the system 20, the account manager is responsible for developing an action plan to address the issue. The customer/respondent action page 130 prompts the account manager to develop and enter the action plan by providing plan box 138. Once an action plan is developed, the account manager enters the action plan in plan box 138 of the respondent action page and it is stored in the databases 28. The action plan is then approved by the account manager's supervisor, and implementation of the action plan is scheduled by the account manager. Each action plan is coded and categorized for future reference. Action plans are coded with sequential numbers for identification purposes. The action plans are categorized so that action plans in response to certain types of issues may be easily identified. For example, an action plan may be categorized as a response to a company quality issue or a response to a company timeliness issue.

Specific issues which are no longer of concern to a particular customer may be deleted by the account manager by choosing the delete issue button 140. If finished viewing the respondent action page, the account manager may choose the return to customer listing option 142 to return to the customer follow-up page 102.

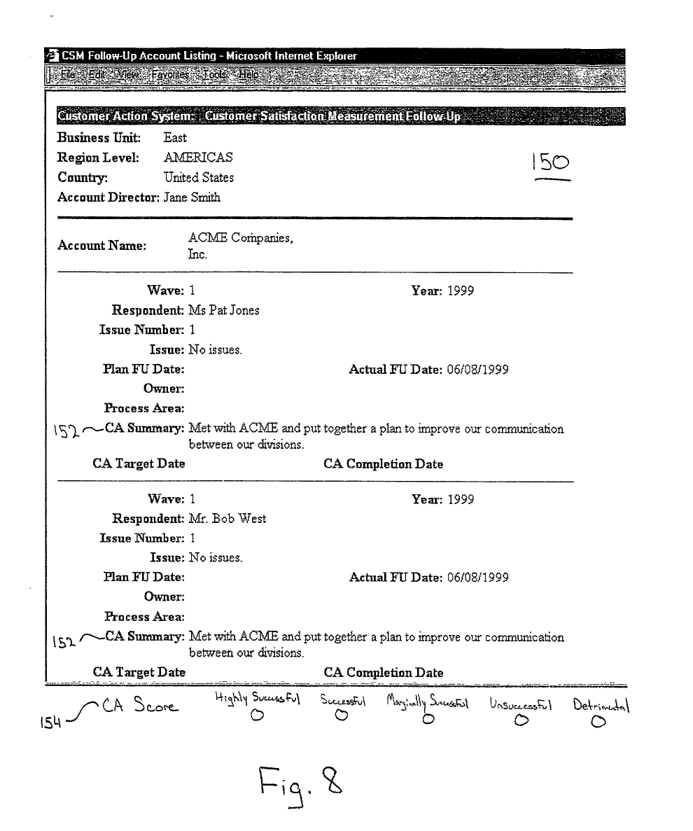

Once an action plan is implemented by an account manager, the results of the action plan are entered on a results page 150. As shown in FIG. 8, the results page 150 lists the particular account name and the respondent targeted by the action. The account manager enters a customer action summary 152 to describe the particular action that took place. Implementation dates of action plans are also entered by the account manager. Finally, the account manager associates a score with each implemented action plan using a scoring device 154. Any number of different methods may be used for scoring the action plan. For example, a five point scale may be used to rate action plans from highly successful to completely unsuccessful or detrimental. The type of scoring device 154 depends upon the method for scoring the action plan used by the company. For example, if a five point scale is used, the scoring device 154 shown in FIG. 8 may be used, allowing the user to simply click on one of the five scores listed under the customer action summary 152 and thereby score the action plan.

Action plans and their results are stored in the database 28 for future reference by other account managers. Account managers may search the databases 28 for the most successful action plans in a particular category, such as customer quality issues. A search may be conducted for action plans in a particular category and having a particular score, such as “highly successful.” In this manner, account managers are provided with assistance when putting together future action plans to deal with issues of customer concern. Account managers may develop an action plan and then search the system to see if any similar action plans were successful or unsuccessful. Of course, the system may be designed to limit access to action plans and their associated scores to those managers in the company hierarchy that are responsible for the particular customer. Thus, high-level managers will be able to view successful action plans implemented by various account managers. These high-level managers may choose to pick certain successful action plans implemented for various customers and share them with other high level managers for recommending to their subordinates. In one alternative embodiment of the invention, e-mail notices are automatically sent to all high level managers when an account manager scores a particular action plan as extremely successful.

High level managers are also provided with access to various reports concerning their subordinates through the account management tool 30. For example, reports may be provided indicating which account managers have yet to enter action plans for at risk customers. Another report may provide a list of account managers yet to complete follow-up actions for at-risk customers. These reports highlight those account managers that are delinquent in their duties and those account managers that are operating within expected deadlines. Other reports may provide a list of customers whose survey results place them in a certain at risk category. To this end, the customer relationship measurement and management system enables company managers to obtain a wealth of information about customer relationships and further provides those managers with a tool for effectively tracking follow up actions of company employees.

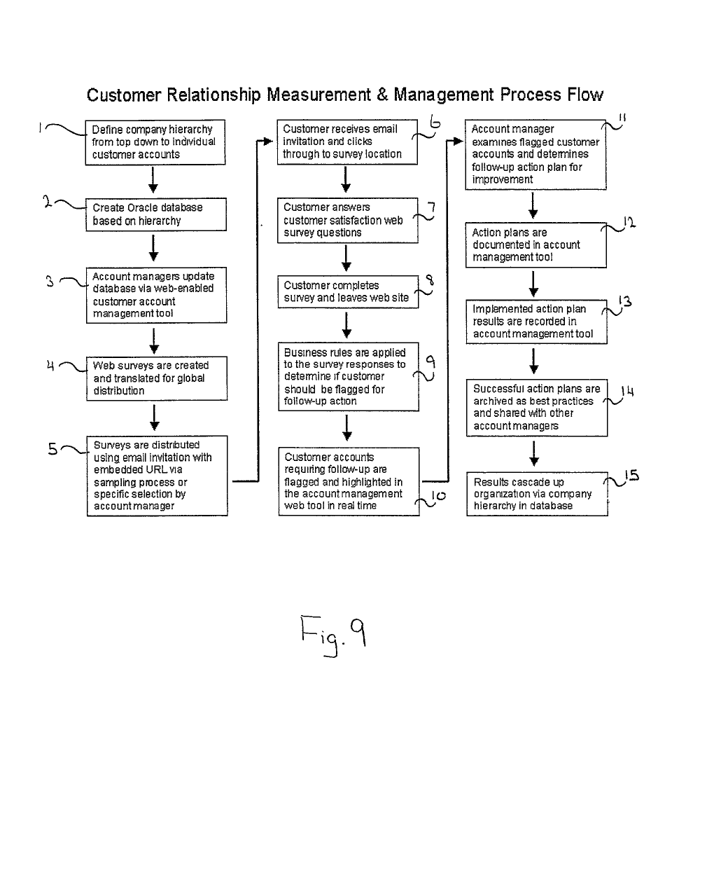

The method of the above system is now summarized with reference to FIG. 9. As shown in FIG. 9, a company hierarchy is first defined in step 1 and includes all customer accounts and account managers responsible for such accounts. In steps 2 and 3, this hierarchy is then stored in the databases 28. The databases may be modified by the company using the web-enabled customer management tool 30. Next, in steps 4 and 5, web surveys are created and distributed to customer employees using an e-mail invitation with an embedded URL which provides each customer employee with access to a survey in the employee's language. Customer employees then log on to the web page identified by the URL, as shown in steps 6, 7 and 8, and work through the survey questions presented by simply clicking on answers in response to the various multiple choice questions, and typing in answers to written questions. Next, in steps 9 and 10, an algorithm is applied to each survey to score the survey and determine if the customer completing the survey should be contacted for follow-up action. In step 11, reports of flagged or “at risk” customers are provided to account managers based upon their responsibility for each at risk customer according to the company hierarchy stored in the database. An action plan in response to issues of each at risk customer is developed by the account manager and recorded in the system in step 12. Results obtained from implementation of the action plan are also recorded in the system as shown in step 13. In step 14, the implemented action plans are scored and archived within the system for sharing with other account managers. Finally, in step 15, the most successful action plans are distributed to other managers within the company hierarchy. These managers can then review the action plans, award account managers who developed the action plans and/or share the successful action plans with other managers within the company.

While the invention has been described with respect to a particular embodiment, other alternative embodiments of the invention are possible. For example, instead of using e-mail invitations, other means may be used by the system to invite customers to complete surveys. Invitations may also be sent by mail, fax, or delivered orally by telephone. Other embodiments of the operation of the invention are also possible. For example, a manager's action plan in response to a customer satisfaction issue may be to develop no action plan or take no action. Such inaction may indicate that the manager does not care if the account is lost. Of course, the above alternatives are but a few of the numerous alternative embodiments of the invention that are possible. Therefore, the spirit and scope of the appended claims should not be limited to the description of preferred versions contained herein.

What is claimed is:

1. A method of managing a relationship between a company and a plurality of customers comprising the steps of:
a. providing at least one database containing information about a plurality of company managers and a plurality of customer respondents;
b. providing a central computer connected to the at least one database, the central computer also connected to a plurality of remote computers through a network;
c. providing a customer satisfaction survey containing a plurality of customer satisfaction questions to a selected respondent of the plurality of customer respondents, the customer satisfaction survey accessible by the selected respondent at a first of the plurality of remote computers;
d. receiving survey answers from the selected respondent at the central computer;
e. processing the survey answers to identify a customer satisfaction issue of the selected respondent;
f. flagging the customer respondent for follow-up action based upon the customer satisfaction issue of the selected respondent; and
g. providing the customer satisfaction issue of the selected respondent to one of the plurality of company managers at a second of the plurality of remote computers, thereby prompting the one of the plurality of company managers to develop an action plan designed to address the customer satisfaction issue of the selected customer respondent.

2. The method of claim 1 further comprising the step of entering the action plan into the at least one database.

3. The method of claim 2 further comprising the step of implementing the action plan to obtain action plan results.

4. The method of claim 3 further comprising the step of associating a score with the action plan based upon the action plan results.

5. The method of claim 4 further comprising the step of making the action plan and the associated score available to the plurality of account managers, thereby providing the plurality of account managers with information about whether the action plan was successful or unsuccessful.

6. The method of claim 1 further comprising the step of sending an invitation to the selected respondent through the first of the plurality of remote computers, the invitation asking the respondent to complete the customer satisfaction survey and providing a network address where the selected respondent may access the customer satisfaction survey.

7. The method of claim 1 wherein the step of processing the survey answers to identify a customer satisfaction issue of the selected respondent includes automatically analyzing the survey answers received from the selected respondent based upon pre-established criteria that identify various customer satisfaction issues.

8. The method of claim 1 wherein the information contained in the at least one database about the selected respondent includes a preferred language of communication.

9. The method of claim 8 further comprising the step of providing a translation tool to a translator, the translation tool accessible by the translator at a third of the plurality of remote computers and providing the translator with the ability to translate each of the plurality of customer satisfaction questions into the preferred language of communication of the selected respondent and thereby produce a translated survey.

10. The method of claim 9 wherein the translated survey is reviewed by an approver before the translated survey is provided to the selected respondent.

11. A system for managing a relationship between a company and a plurality of customers comprising:
a. at least one database containing information about a plurality of customer respondents and a plurality of company managers associated with each of the plurality of customer respondents;
b. means for delivering a customer satisfaction survey containing a plurality of customer satisfaction questions to a selected respondent of the plurality of customer respondents;
c. means for receiving survey answers from the selected respondent;
d. means for processing the survey answers to identify a customer satisfaction issue of the selected respondent;
e. means for flagging the customer respondent for follow-up action based upon the customer satisfaction issue of the selected respondent; and
f. means for providing the customer satisfaction issue of the selected respondent to one of the plurality of company managers, thereby prompting the one of the plurality of company managers to develop an action plan designed to address the customer satisfaction issue of the selected customer respondent.

12. The system of claim 11 further comprising means for entering the action plan into the at least one database.

13. The system of claim 12 further comprising means for associating a score with the action plan based upon action plan results obtained after implementation of the action plan.

14. The system of claim 13 further comprising means for making the action plan and the associated score available to the plurality of account managers, thereby providing the plurality of account managers with information about whether the action plan was successful or unsuccessful.

15. The system of claim 11 further comprising means for inviting the selected respondent to complete the customer satisfaction survey using one of the plurality of remote computers, the means for inviting providing a network address where the selected respondent may access the customer satisfaction survey.

16. The system of claim 11 wherein the means for processing the survey answers to identify a customer satisfaction issue of the selected respondent includes means for automatically analyzing the survey answers received from the selected respondent based upon pre-established criteria that identify various customer satisfaction issues.

17. The system of claim 11 wherein the information contained in the at least one database about the selected respondent includes a preferred language of communication.

18. The system of claim 17 further comprising a translation means accessible by a translator at one of the plurality of remote computers, the translation means providing the translator with the ability to translate each of the plurality of customer satisfaction questions into the preferred language of communication of the selected respondent and thereby produce a translated survey.

19. The system of claim 18 further comprising a means for delivering the translated survey to an approver for review and approval.

20. A system for managing relationships between a company and a plurality of customers comprising:
a. at least one database containing information about a plurality of customer respondents and a plurality of company managers associated with each of the plurality of customer respondents;
b. a central computer connected to the at least one database, the central computer comprising
i. an account management tool accessible by the plurality of company managers at one of a plurality of remote computers connected to the central computer, the account management tool including (a) an account information page operable to display a plurality of customer respondents, and (b) a customer action page accessible through the account information page and operable to display a customer satisfaction issue identified by one of the plurality of customer respondents and prompt one of the plurality of company managers to enter an action plan to address the customer satisfaction issue;
ii. a customer survey tool operable to provide a customer satisfaction survey to each of the plurality of customer respondents at one of the plurality of remote computers.

21. The system of claim 20 wherein the account management tool further comprises a results page operable to display action plan results following implementation of the action plan and further operable to allow one of the plurality of company managers to associate a score with the action plan results.
